(19) United States
(12) Patent Application Publication
(10) Pub. No.: US 2019/0056063 A1
(43) Pub. Date: Feb. 21, 2019

(54) Method for Operating A Liquefied Gas Tank and Liquefied Gas Tank for Receiving LNG and Boil-Off Gas

(71) Applicant: TGE MARINE GAS ENGINEERING GmbH, Bonn (DE)

(72) Inventors: Jürgen ESSLER, Wunstorf (DE); Thomas TIEDEMANN, Wachtberg (DE); Andreas HAMBÜCKER, Bonn (DE); Hans-Christian HAARMANN-KÜHN, Brühl (DE)

(73) Assignee: TGE Marine Gas Engineering GmbH, Bonn (DE)

(21) Appl. No.: 16/078,932

(22) PCT Filed: Feb. 14, 2017
(86) PCT No.: PCT/EP2017/000205

§ 371 Date: Aug. 22, 2018

(30) Foreign Application Priority Data
Feb. 29, 2016 (DE) 10 2016 002 316.3

(51) Int. Cl. F17C 7/02; B63B 25/16

(52) U.S. Cl. CPC F17C 7/02; B63B 25/16; F17C 2221/033; B63B 2025/087; F17C 2270/0113; F17C 2265/03; F17C 2270/0105

(57) ABSTRACT

The invention relates to a method for operating a liquefied gas storage tank (1) having a tank volume (2) for receiving LNG and boil-off gas (BOG), wherein a gaseous BOG stream and a liquid LNG stream are fed to the tank volume, and wherein the BOG stream is introduced into the LNG stream, and wherein subsequently the resulting BOG-LNG mixture is introduced into the tank volume. The invention also relates to a corresponding liquefied gas storage tank.

This invention relates to a method for operating a liquefied gas storage tank and a liquefied gas storage tank with a tank volume for receiving Liquefied Natural Gas (LNG) and Boil-Off Gas (BOG), and to a Floating Storage Unit (FSU), an LNG carrier, a regas barge, an LNG-operated vehicle and an LNG-operated power plant, each with such a liquefied gas storage tank.

Liquefied gas storage tanks for storing LNG are used among other things as transport tanks in LNG carriers or as hold-up tanks (for example FSUs or regas barges), for example after an overseas transport before feeding into a consumer network, or as storage/fuel tanks (for example in LNG-operated sea or land vehicles or in stationary gas power plants).

Independent of the kind of use of the liquefied gas storage tank, the LNG present therein in principle is exposed to a slow, but steady heating despite the use of extensive heat insulation measures, because of the large temperature difference to the air of the surroundings of the tank.

The more this heating of the LNG proceeds the larger is the amount of stored LNG that passes from the liquid into the gaseous phase and hence increases as so-called BOG the internal pressure in a tank volume of the liquefied gas storage tank. Like the heating, this pressure increase also takes place slowly, but steadily. Unless countermeasures are taken in good time, the tank shell threatens to fracture sooner or later depending on the tank construction.

Therefore, in known liquefied gas storage tanks there is normally provided a possibility to discharge the BOG and subsequently either burn the same freely or supply it to a consumer.

There are also known solutions in which the BOG is compressed, liquefied again and subsequently recirculated into the tank volume of the liquefied gas storage tank as LNG. The solutions known in this respect, however, need complex and installation-space-intensive processing circuits for the LNG and/or the BOG in order to again transfer the latter into the liquid phase.

From the U.S. Pat. No. 3,733,838 a system for reliquefying BOG is known, in which liquid LNG is withdrawn from the tank, heated by means of a heat exchanger and a heater and transferred into the gaseous phase. This gaseous LNG subsequently is mixed with the BOG likewise discharged from the tank, cooled in the above-mentioned heat exchanger and after passing through an expansion valve is again introduced into the tank in the liquid phase. This process requires a heat exchanger that limits the flexibility of the line routing, and an active heater that contravenes the objective to minimize the thermal energy and hence the build-up of pressure in the tank.

Another solution according to the European Patent Application EP 1 956 287 A2 can do without an active heater, but requires two separate fluid circuits in order to provide the required condensation performance. In the first circuit, BOG from the upper part of the tank is pressed into the lower part of the tank; in the second circuit, LNG from the lower part of the tank is sprayed in the upper part of the tank. The necessary condensation hence is achieved by two measures ultimately provided separate from each other, which both must be mounted on the tank and in the tank with great expenditure.

It now is an object of the invention to provide a sufficient capacity for the liquefaction of BOG in a simpler way.

This object is solved by means of a method with the features of independent claim 1 and by means of a liquefied gas storage tank with the features of independent claim 7. An FSU, an LNG carrier, a regas barge, an LNG-operated vehicle and an LNG-operated power plant are claimed in claim 15.

According to one aspect of the invention there is proposed a method for operating a liquefied gas storage tank having a tank volume for receiving LNG and boil-off gas (BOG), wherein a gaseous BOG stream and a liquid LNG stream are supplied to the tank volume. In the method, the BOG stream is introduced into the LNG stream and subsequently the resulting BOG-LNG mixture is introduced into the tank volume.

According to another aspect of the invention there is proposed a liquefied gas storage tank having a tank volume for receiving LNG and boil-off gas (BOG), which includes a BOG conduit for conducting gaseous BOG and an LNG conduit for conducting liquid LNG. The BOG conduit and the LNG conduit open into a common BOG-LNG conduit that is formed for conducting a BOG-LNG mixture and that opens into the tank volume.

In particular to be able to apply the invention as broadly as possible and/or to even intensify the advantages of the invention by applying the same at several points in a liquefied gas supply chain, an FSU, an LNG carrier, a regas barge, an LNG-operated sea or land vehicle or an LNG-operated power plant, each with at least one liquefied gas storage tank in accordance with the invention, is proposed according to further aspects of the invention.

Due to a design according to the invention, a BOG liquefaction process to be realized very easily in constructional terms can be achieved with a reduced expenditure of installation space and a minimized demand of line and thermal management components, which also can provide for an improved liquefaction performance. There can also be provided a liquefied gas storage tank that requires a smaller number of apertures in the tank shell.

The invention is based on the idea to provide the bringing together of the liquid LNG and the gaseous BOG upstream in the liquefaction circuit as far as possible and to at the same time ensure that the BOG is introduced into LNG which is flowing by—and not static. On the one hand, an input of heat along superfluous pipe conduits thereby can be omitted and on the other hand the take-up and condensation of the gaseous BOG in the liquid LNG can be simplified.

Pressing the BOG into the LNG stream works the better the more the pressure of the BOG stream lies above a saturation pressure of the LNG stream. Whether the pressure in the BOG stream is increased by a compressor at the upstream end or the BOG is directly supplied from another tank (synonymously: reservoir), in which it already is present at a—relatively—high pressure, is irrelevant.

The condensation of the initially gaseous BOG after introduction into the LNG stream works the better the more pronounced the sub-cooling of the LNG stream—based on the pressure conditions in the tank volume of the liquefied gas storage tank. As long as the LNG stream is sub-cooled in this sense, the introduced BOG stream can be condensed (synonymously: condensed in, dissolved in, pressed in, injected).

The operation of a liquefied gas storage tank in accordance with the invention can include both a filling and a draining of its tank volume with LNG and/or BOG, and a storage operation, wherein it is necessary in the course of time to counteract the rising tank pressure that is caused by an increasing BOG content. The term “operation” here includes both a change of the filling quantity of LNG and/or BOG (and hence mostly also a change in the BOG pressure) and a pressure regulation with the filling quantity substantially remaining the same.

In the present case, boil-off gas (BOG) is understood to be gaseous LNG, in particular such LNG that due to changing temperature or pressure conditions in a tank has passed from the liquid phase into the gaseous phase. In accordance with the invention, BOG can have been “formed” in the tank volume of a liquefied gas storage tank according to the invention or a development, but can also originate from a conventional tank from which the tank volume has been filled in accordance with the invention.

Conduit in accordance with the invention in particular is understood to be a pipe conduit or an assembly of several pipe conduits, wherein the pipe conduits preferably are equipped to transport LNG and/or BOG under the temperature and/or pressure conditions customary for the transport of liquefied gas. To this end, corresponding reinforcements and/or insulations can possibly be provided.

To be able to also load the liquefied gas storage tank by using a method in accordance with the invention and hence to be able to additionally save installation space and possibly line components, at least a part of the BOG for the BOG stream and/or at least a part of the LNG for the LNG stream according to a preferred development is supplied to the liquefied gas storage tank from outside the tank volume, in particular from at least one connected reservoir of a Floating Storage Unit (FSU) or an LNG carrier or a regas barge. To this end, loading conduits for BOG and/or LNG preferably are provided.

Various functions in operation of the liquefied gas storage tank, such as for example the loading and the pressure regulation for the BOG present already in the liquefied gas storage tank, hence can be combined or be carried out at the same time.

According to a preferred development, at least a part of the BOG for the BOG stream and/or at least a part of the LNG for the LNG stream are withdrawn from the tank volume of the liquefied gas storage tank itself, in particular to be able to carry out a pressure regulation within the tank volume also independent of a loading operation or an unloading operation. To this end, recirculation conduits for BOG and/or LNG preferably are provided, in which the BOG stream and the LNG stream are brought together in accordance with the invention.

The pressure and/or temperature conditions within the tank volume thereby can be kept in a desired range for a longer time.

Preferably, LNG is pumped by means of a pump from a lower region of the tank volume into an LNG conduit and/or BOG is sucked off from an upper region of the tank volume by means of a BOG conduit and a compressor arranged therein. The resulting streams of LNG and BOG then are preferably brought together with each other in accordance with the invention.

To be able to carry out a pressure regulation in the liquefied gas storage tank as flexibly as possible and in a finely adjustable way, BOG from the tank volume and from at least one connected reservoir is supplied to the BOG stream according to a preferred development and/or LNG from the tank volume and from at least one connected reservoir is supplied to the LNG stream.

Preferably, it is provided that the loading conduits (synonymously: filling assemblies) and/or the recirculation conduits (synonymously: recirculation circuits) are formed to lead into each other and jointly can open into the tank volume. For example, the LNG loading conduit and the LNG recirculation conduit on the one hand and the BOG loading conduit and the BOG recirculation conduit on the other hand can first be brought together, i. e. combined, in flow direction, and subsequently the combined LNG conduit and the combined BOG conduit can be joined in accordance with the invention.

To be able to also condense BOG not present in the BOG stream, the BOG-LNG mixture according to a preferred development is introduced, in particular sprayed, into gaseous BOG above an LNG filling level of the tank volume. Preferably, on introduction the entire BOG-LNG mixture conducted in a common BOG-LNG conduit already is present in the liquid phase and/or particularly preferably still is sub-cooled with respect to the pressure conditions in the tank volume despite the already effected introduction of relatively warmer BOG.

Alternatively or in addition, the BOG-LNG mixture according to a preferred development is introduced into liquid LNG below an LNG filling level of the tank volume. This can provide for an optimum intermixing of the content of the tank volume in particular with regard to a temperature distribution.

To ensure that the liquefied gas storage tank can also be filled by means of a common BOG-LNG conduit in accordance with the invention and hence to additionally be able to save installation space and possibly line components, the BOG conduit and/or the LNG conduit according to a preferred development, in particular at its end away from the tank volume, includes a fluid interface to at least one connectable reservoir, in particular to a Floating Storage Unit (FSU) or an LNG carrier or a regas barge, and/or is equipped to supply BOG or LNG to the tank volume from a connected reservoir.

Such a fluid interface—depending on what kind of conduit it terminates—can be configured as an LNG interface and/or as a BOG interface. This can also be an interface standardized for the handling of LNG or BOG, but also an interface adapted to the connection of a particular kind of reservoir to the liquefied gas storage tank.

To provide for a pressure regulation in the tank volume independent of a filling operation, the BOG conduit according to a preferred development is equipped to withdraw gaseous BOG from the tank volume above an LNG filling level and/or the LNG conduit is equipped to withdraw liquid LNG from the tank volume below an LNG filling level.

An LNG filling level according to the invention for example can be a predetermined filling level and/or a height region that indicates the maximum and the minimum filling level of the tank volume with liquid LNG. Preferably, in the second case a BOG conduit for the withdrawal of BOG is arranged above an upper limit value of the height region (because in the normal case BOG always is present there), and an LNG conduit for the withdrawal of LNG is arranged below a lower limit value of the height region (because in the normal case LNG always is present there).

To be able to also condense BOG not present in the BOG stream, the orifice of the common BOG-LNG conduit into the tank volume according to a preferred development is arranged above a, in particular predetermined, LNG filling level of the tank volume.

Preferably, the orifice includes a spray nozzle for spraying the BOG-LNG mixture, in particular to achieve an optimized condensation effect with regard to the BOG present above the LNG filling level.

Alternatively or in addition, the orifice of the common BOG-LNG conduit into the tank volume is arranged below an, in particular predetermined, LNG filling level of the tank volume in order to achieve an optimum intermixing of the liquid LNG in the tank volume, in particular with regard to a uniform temperature distribution.

To also reduce the piping necessary for incorporation into customer or consumer networks, the LNG conduit according to a preferred development includes an interface to a customer/consumer network that is equipped to feed LNG from the tank volume into the customer/consumer network. For the same reason, the BOG conduit according to a preferred development includes an interface to a customer/consumer network that is equipped to feed BOG from the tank volume into the customer/consumer network.

Advantageous embodiments of the various aspects of the invention are subject-matter of the sub-claims. Further features, advantages and possible applications of the invention can be taken from the following description in conjunction with the Figures, wherein similar components in different Figures can be designated with the same reference numeral. In the drawings, partly in a strongly schematic representation,

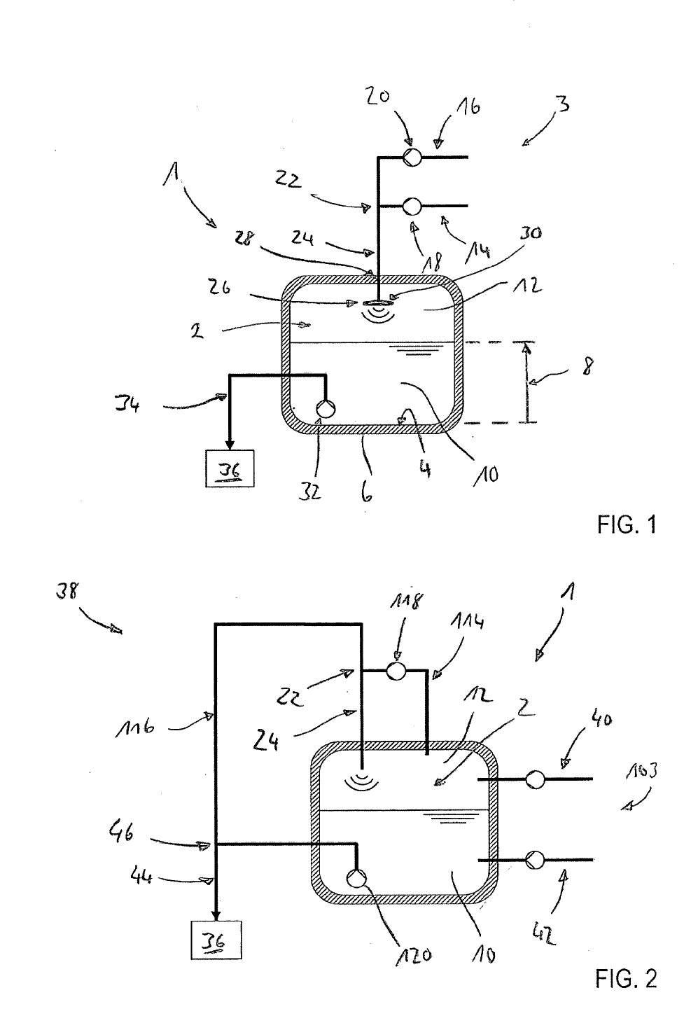

FIG. 1 shows a sectional view of a liquefied gas storage tank according to an embodiment of the invention with an externally supplied BOG-LNG conduit;

FIG. 2 shows a sectional view of a liquefied gas storage tank according to another embodiment of the invention with a BOG-LNG conduit supplied from the tank volume;

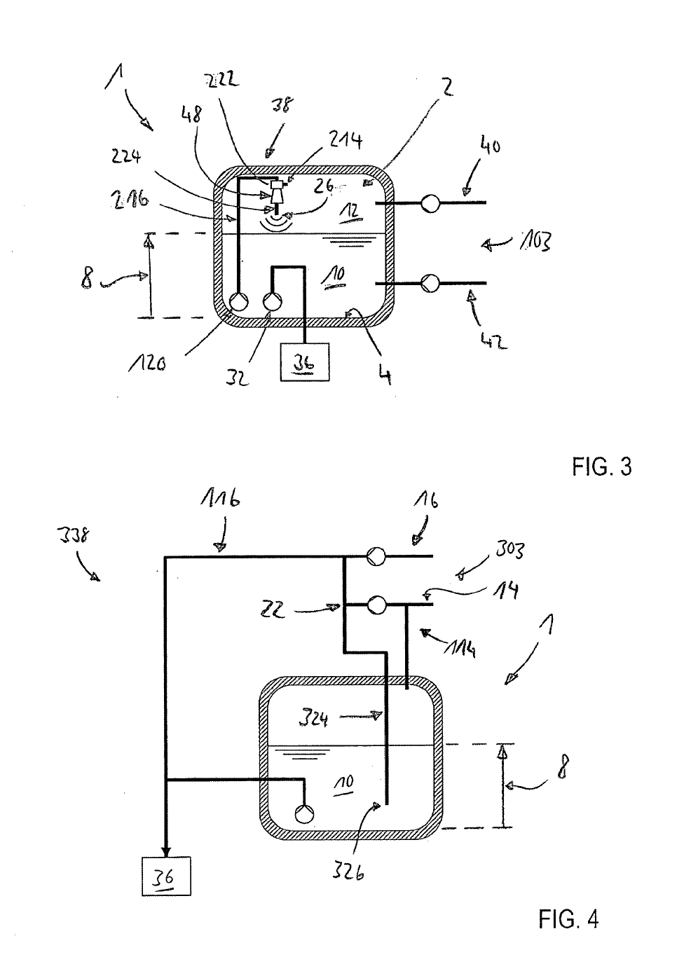

FIG. 3 shows a sectional view of a liquefied gas storage tank according to another embodiment of the invention, in which the BOG conduit and the LNG conduit are arranged completely within the tank shell;

FIG. 4 shows a sectional view of a liquefied gas storage tank according to another embodiment of the invention, wherein the BOG-LNG mixture is injected below the LNG filling level;

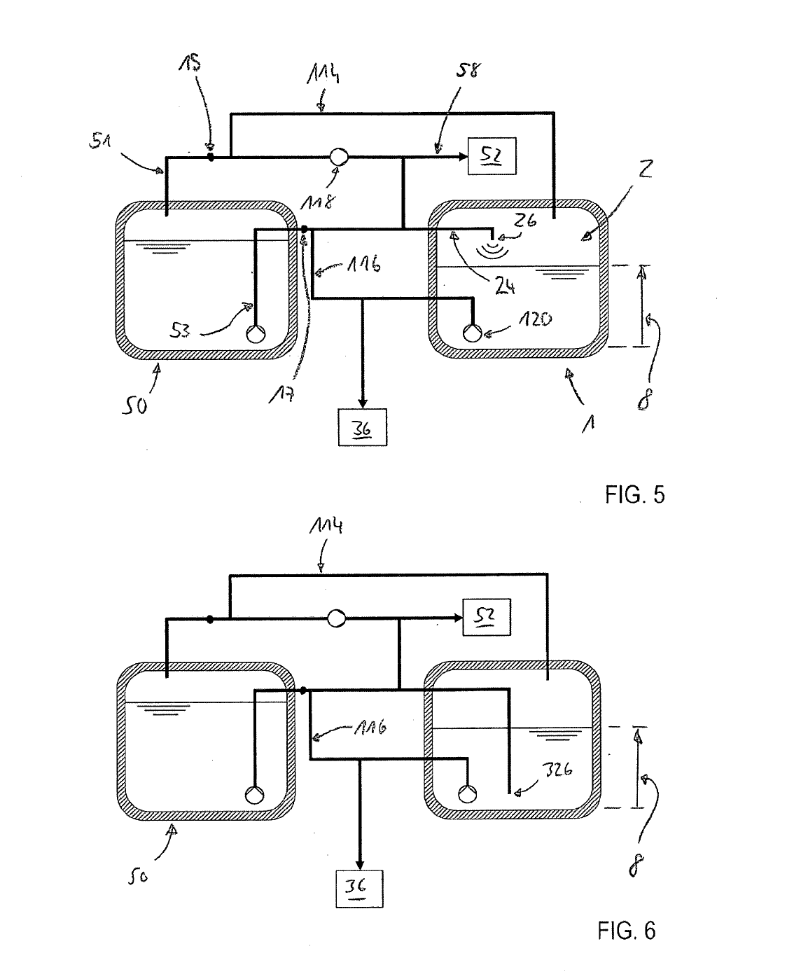

FIG. 5 shows a sectional view of a liquefied gas storage tank according to another embodiment of the invention, to which a coupleable transport tank and customer networks are connected;

FIG. 6 shows a sectional view of a liquefied gas storage tank that in particular differs from the one according to FIG. 5 in that the BOG-LNG mixture is injected below the LNG filling level; and

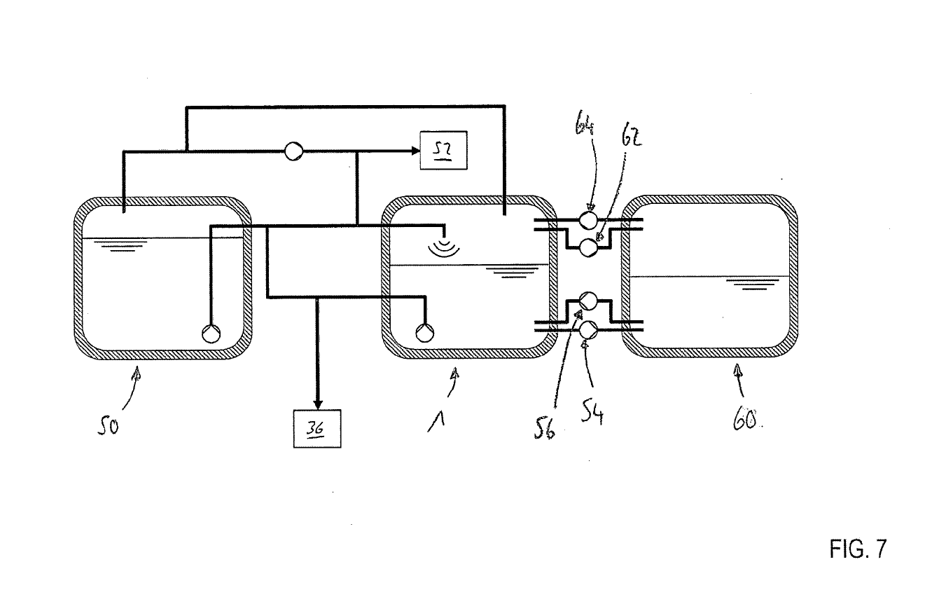

FIG. 7 shows a sectional view of a liquefied gas storage tank to which beside a coupleable transport tank and customer networks a firmly installed storage tank also is connected.

FIG. 1 shows a liquefied gas storage tank 1 with a tank volume 2, in which the invention is applied to a filling assembly 3.

The liquefied gas storage tank 1 is delimited by a tank shell 4 that is thermally insulated with respect to the surroundings of the liquefied gas storage tank 1 by means of a heat insulation layer 6. The liquefied gas storage tank 1 is filled with liquid LNG 10 up to an LNG filling level 8; above the LNG filling level 8 the liquefied gas storage tank 1 is filled with gaseous BOG 12.

The liquefied gas storage tank 1 includes a BOG conduit 14 for conducting gaseous BOG, via which BOG can be supplied to the tank volume 2 from an external source. The liquefied gas storage tank 1 also includes an LNG conduit 16 for conducting liquid LNG, via which LNG can be supplied to the tank volume 2 from an external source. In this exemplary embodiment, a conduit compressor 18 is mounted in the BOG conduit 14 and a conduit pump 20 is mounted in the LNG conduit 16 for a sufficient conveyance or compression.

Downstream of the conduit compressor 18 and of the conduit pump 20 there is provided a joining point 22 at which a pipe conduit element of the BOG conduit 14 and a pipe conduit element of the LNG conduit 16 open into a common BOG-LNG conduit 24. In the exemplary embodiment, the common BOG-LNG conduit 24 is configured as a pipe conduit element and extends from the joining point 22 up to an orifice point 26 within the tank volume 2, wherein the pipe conduit element traverses the tank shell 4 at a breakthrough point 28.

At the orifice point 26 the BOG-LNG conduit 24 ends with a spray nozzle 30, wherein the orifice point 26 is arranged above the LNG filling level 8.

Below the LNG filling level 8 an unloading pump 32 is provided for conveying liquid LNG 10 through an unloading conduit 34 towards an interface of an LNG consumer network 36.

The liquefied gas storage tank 1 according to this embodiment hence can be loaded from a non-illustrated, external source of LNG and/or BOG, for example an LNG carrier, and independently be unloaded again in the direction of an LNG consumer network 36.

By joining a BOG stream in the BOG conduit 14 and an LNG stream in the LNG conduit 16 at the joining point 22 according to the invention, the gaseous BOG can already be condensed into the anyway liquid LNG before entry into the tank volume 2 of the liquefied gas storage tank 1.

In this exemplary embodiment, the necessary pressure is provided by the compressor 18; it would also be conceivable, however, that the BOG from the external source already is provided with sufficiently high pressure. Based on the existing conditions, the supplied LNG is sub-cooled and thus can liquefy the BOG pressed in.

By joining at an early stage already at the joining point 22, the length of the pipe conduit elements required altogether can be reduced distinctly; moreover, there is only required one breakthrough point 28 through the tank shell 4, instead of at least two of such apertures in the case of a separate conduit. This simplifies the manufacture of the liquefied gas storage tank 1, as compared with a conventional design.

By spraying the BOG-LNG mixture by means of the spray nozzle 30 into the BOG 12 present already in the tank volume 2, gaseous BOG 12 additionally is liquefied and thus—in relative terms—the pressure in the tank volume 2 is reduced.

FIG. 2 shows a liquefied gas storage tank 1, in which the invention is applied to a recirculation circuit 38.

The liquefied gas storage tank 1 of this embodiment includes a conduit pump 120 for conveying LNG into the LNG conduit 116. The liquefied gas storage tank 1 also includes a BOG conduit 114 in which a conduit compressor 118 is arranged.

The LNG conduit 116 and the BOG conduit 114 converge in the joining point 22 and open into the common BOG-LNG conduit 24.

To provide for filling of the liquefied gas storage tank 1 with BOG or LNG (filling assembly 103) a BOG loading conduit 40 is provided, which opens above the LNG filling level within the tank volume 2, and an LNG loading conduit 42 which opens below the LNG filling level.

To provide for draining of the liquefied gas storage tank an unloading conduit 44 branches off from the LNG conduit 116, which can be connected to an LNG consumer network 36 via a standard interface. At the separation point 46 it can be switched via a suitably switchable, non-illustrated valve whether the LNG is conducted in the direction of the joining point 22 and/or in the direction of the consumer network 36.

In the liquefied gas storage tank 1 according to this embodiment the quantity of the BOG 12 present in gaseous form can be reduced by means of the recirculation circuit 38 independent of loading and/or unloading operations and hence the pressure in the tank volume 2 can be reduced.

For this purpose, gaseous BOG 12 is sucked off from the upper part of the tank volume (above the LNG filling level) by means of the conduit 114 and the associated compressor 118 and liquefied by pressing it into the sub-cooled LNG conveyed into the conduit 116 by means of the pump 120. This is accomplished in the common conduit 24 from the joining point 22.

Due to the subsequent injection (spray nozzle 30 is not shown here) a part of the BOG 12 not sucked off additionally is liquefied in the tank volume, which additionally reduces the pressure in the tank volume 2. This method can be carried out as long as the liquid LNG 10, which is heated by feeding in the relatively warmer gaseous BOG 12, still is sub-cooled—based on the pressure conditions prevailing in the tank. Cooling by an externally supplied, relatively cold LNG therefore only becomes necessary at a distinctly later time.

FIG. 3 shows a liquefied gas storage tank 1 in which the BOG conduit and the LNG conduit of the recirculation circuit 38 are arranged completely within the tank shell 4. This liquefied gas storage tank also includes a filling assembly 103 and an interface to the LNG consumer network 36 that is configured analogous to FIG. 1.

To form the recirculation circuit 38, an LNG conduit 216 and a rudimentary BOG conduit 214 are formed within the tank shell 4. The two conduits 216 and 214 both open into a Venturi nozzle 48 that is arranged above the LNG filling level 8. The joining point 222 is arranged at the inlets of the Venturi nozzle 48; the orifice point 26 is arranged at the common BOG-LNG conduit 224, which proceeds from the downstream end of the Venturi nozzle 48.

The recirculation circuit 38 hence is designed such that no aperture of the tank shell 4 is necessary therefor and it also requires only relatively short pipe conduit elements.

For pressure regulation in this embodiment, liquid LNG 10 is conveyed to the Venturi nozzle 48 by means of the pump 120, which in the nozzle 48 can entrain gaseous BOG 12 that is under the pressure of the tank volume 2. In the representation of FIG. 3 a very short BOG conduit 214 is depicted, which might however also be omitted as long as the Venturi nozzle 48 has a suitable inlet.

FIG. 4 shows a liquefied gas storage tank 1 in which the filling assembly 3 of FIG. 1 and the recirculation circuit 38 of FIG. 2 substantially are combined with each other, so that in the embodiment described here an integrated line assembly is formed with a recirculation circuit 338 and a filling assembly 303.

Other than in the embodiments according to FIGS. 1 and 2, the BOG-LNG mixture in the representation of FIG. 4 is pressed into the liquid LNG 10 at the end of the common BOG-LNG conduit below the LNG filling level 8. Due to this configuration, for example the spray nozzle 30 according to FIG. 1 can be saved when the additional liquefaction capacity realized thereby is not needed.

FIG. 5 shows a liquefied gas storage tank 1 to which a coupleable transport tank 50 (for example of an LNG carrier) and customer networks (LNG customer network 36 and BOG customer network 52) are connected or can be connected.

Apart from the deviations described below, the embodiment of the liquefied gas storage tank 1 as shown in FIG. 5 substantially represents the same as in FIG. 4, except that the connected “external source” with the transport tank 50 is shown explicitly with its BOG connecting line 51 (functionally at least in part corresponds to the BOG conduit 14 in FIG. 1) and its LNG connecting line 53 (functionally at least in part corresponds to the LNG conduit 16 in FIG. 1). The BOG connecting line 51 is connected to the BOG conduit 114 according to FIG. 5 by means of a BOG fluid interface 15, and the LNG connecting line 53 is connected to the LNG conduit 116 according to FIG. 5 by means of an LNG fluid interface 17.

In addition, the embodiment according to FIG. 5 differs from the one according to FIG. 4 by the possibility to feed BOG (both from the tank volume 2 and from the transport tank 50) into a BOG consumer network 52 via a non-illustrated valve and an unloading line 58. Other than in FIG. 4, the BOG-LNG mixture is sprayed in above the LNG filling level 8.

The embodiment shown in FIG. 6 only differs from the one according to FIG. 5 in that the BOG-LNG mixture is pressed in below the LNG filling level 8 like in FIG. 4.

FIG. 7 shows a liquefied gas storage tank 1 to which beside a coupleable transport tank 50 and customer networks 36 and 52 a firmly installed storage tank 60 also is connected.

The storage tank 60 substantially includes only interfaces to the liquefied gas storage tank 1 with respect to BOG and with respect to LNG. Below the LNG filling level (of both tanks) both an LNG pump 54 for conveying LNG from the liquefied gas storage tank 1 into the storage tank 60 and an LNG pump 56 for conveying LNG from the storage tank 60 into the liquefied gas storage tank 1 is provided. Above the LNG filling level both a BOG compressor 62 for conveying BOG from the liquefied gas storage tank 1 into the storage tank 60 and a BOG compressor 64 for conveying BOG from the storage tank 60 into the liquefied gas storage tank 1 is provided. The storage tank 60 hence is provided downstream of or subordinated to the liquefied gas storage tank 1 so to speak as a volume and/or cold capacity expansion.

The storage tank 60 for example can be used as a reservoir for strongly sub-cooled LNG by being filled with such sub-cooled LNG when it is just available in large quantities—for example as a result of an arriving shipload. When in a later operating phase for example a large amount of relatively warm BOG must be taken over from another transport tank 50 of an LNG carrier, the same can be recondensed for a long time in the liquefied gas storage tank 1, because cold LNG can be supplied from the storage tank 60.

Also independent of the necessity to take over warm BOG from a transport tank 50, the storage tank 60 can serve the longer-term stabilization of the sub-cooling of the LNG in the liquefied gas storage tank 1, in that warmer LNG from the liquefied gas storage tank 1 is pumped into the storage tank 60 and is mixed there with the relatively cold LNG, and at a later time or at the same time colder LNG is pumped from the storage tank into the liquefied gas storage tank 1.

The embodiments of liquefied gas storage tanks 1 in accordance with the invention as shown in FIGS. 5, 6 and 7 illustrate the typical case of a regas barge (which here accommodates the liquefied gas storage tank 1 in accordance with the invention), which serves as a hold-up tank for BOG 12 and/or LNG 10 after delivery by an LNG carrier (here with the transport tank 50) and before feeding into consumer networks 36 and/or 52. By using a liquefied gas storage tank 1 in accordance with the invention, the duration of the temporary storage in the regas barge, which is not influenced from outside, can be prolonged distinctly with a very simple construction.

1. A method for operating a liquefied gas storage tank (1) having a tank volume (2) for receiving liquefied natural gas (LNG) (10) and boil-off gas (BOG) (12), wherein a gaseous BOG stream and a liquid LNG stream are supplied to the tank volume, the method comprising the steps of:
introducing the BOG stream into the LNG stream; and
subsequently introducing the resulting BOG-LNG mixture into the tank volume.

2. The method according to claim 1, wherein at least a part of the BOG for the BOG stream and/or at least a part of the LNG for the LNG stream is supplied to the liquefied gas storage tank proceeding from outside the tank volume, in particular from at least one connected reservoir (50) of a Floating Storage Unit (FSU) or an LNG carrier or a regas barge.

3. The method according to claim 1, wherein at least a part of the BOG for the BOG stream and/or at least a part of the LNG for the LNG stream is withdrawn from the tank volume.

4. The method according to claim 1, wherein BOG from the tank volume and from at least one connected reservoir (50) is supplied to the BOG stream, and/or wherein LNG from the tank volume and from at least one connected reservoir (50) is supplied to the LNG stream.

5. The method according to claim 1, wherein the BOG-LNG mixture is introduced, in particular sprayed, into gaseous BOG (12) above an LNG filling level (8) of the tank volume.

6. The method according to claim 1, wherein the BOG-LNG mixture is introduced into liquid LNG (10) below an LNG filling level of the tank volume.

7. A liquefied gas storage tank (1) with a tank volume (2) for receiving liquefied natural gas (LNG) (10) and boil-off gas (BOG) (10), the liquefied gas storage tank comprising:
a BOG conduit (14, 114, 214) for conducting gaseous BOG,
an LNG conduit (16, 116, 216) for conducting liquid LNG,
wherein the BOG conduit and the LNG conduit open into a common BOG-LNG conduit (24, 224, 324) that is formed to conduct a BOG-LNG mixture and that opens into the tank volume.

8. The liquefied gas storage tank according to claim 7, wherein the BOG conduit and/or the LNG conduit, in particular at their end away from the tank volume, includes a fluid interface (15; 17) to at least one connectable reservoir (50), in particular to a Floating Storage Unit (FSU) or an LNG carrier or a regas barge, and is equipped to supply BOG or LNG from a connected reservoir to the tank volume.

9. The liquefied gas storage tank according to claim 7, wherein the BOG conduit is equipped to withdraw gaseous BOG from the tank volume above an LNG filling level (8) and/or wherein the LNG conduit is equipped to withdraw liquid LNG from the tank volume below an LNG filling level.

10. The liquefied gas storage tank according to claim 7, wherein the orifice (26, 326) of the common BOG-LNG conduit into the tank volume is arranged above an, in particular predetermined, LNG filling level of the tank volume.

11. The liquefied gas storage tank according to claim 10, wherein the orifice includes a spray nozzle (30) for spraying the BOG-LNG mixture.

12. The liquefied gas storage tank according to claim 7, wherein the orifice of the common BOG-LNG conduit into the tank volume is arranged below an, in particular predetermined, LNG filling level of the tank volume.

13. The liquefied gas storage tank according to claim 7, wherein the LNG conduit includes an interface to a consumer network (36) that is equipped to feed LNG from the tank volume into the consumer network.

14. The liquefied gas storage tank according to claim 7, wherein the BOG conduit includes an interface to a consumer network (52) that is equipped to feed BOG from the tank volume into the consumer network.

15. A Floating Storage Unit (FSU) or LNG carrier or regas barge or LNG-operated vehicle or LNG-operated power plant with at least one liquefied gas storage tank (1) according to claim 7.
